(19) United States
(12) Patent Application Publication
(10) Pub. No.: US 2026/0027633 A1
(43) Pub. Date: Jan. 29, 2026

(54) MODULAR FLIP STOP MEASURING SYSTEM WITH A TURNED ROUND BASE

(71) Applicant: Mark Duginske, Merrill, WI (US)

(72) Inventor: Mark Duginske, Merrill, WI (US)

(21) Appl. No.: 19/281,564

(22) Filed: Jul. 26, 2025

Related U.S. Application Data
(60) Provisional application No. 63/676,117, filed on Jul. 26, 2024.

(51) Int. Cl. B23D 59/00; B23D 47/02

(52) U.S. Cl. CPC B23D 59/001; B23D 47/025

(57) ABSTRACT

A modular flip stop measuring system designed for woodworking and metalworking applications, featuring adjustable height options and compatibility with various T-slot tracks, The adjustable flip stop measuring system is a modular assembly designed for precise measurement and cutting in woodworking applications. The system consists of three main extrusions: the adjustable bracket, rotation base, and flip stop arm. The adjustable bracket has 9 staggered flanges, allowing for 9 different height adjustments.

### CROSS REFERENCE TO RELATED APPLICATION

This application claims the benefit of U.S. Provisional Application 63/676,117, filed Jul. 26, 2024.

### FIELD OF THE INVENTION

The jigs, fixtures, and measuring systems that are accessories for woodworking or metalworking operations for accurately and repeatedly spacing crosscuts, dadoes, drill holes, or pocket holes, and more particularly towards a modular and adjustable positioning flip stop which measures the distance between a workpiece and a saw blade, router, drill bit, or similar cutting tool.

### BACKGROUND OF THE INVENTION

Woodworking has been prevalent in human civilization dating back to the prehistoric era. Early humans crafted wood into spears, clubs, tools, furniture, and shelters. As civilization advanced into the industrial revolution and modern age, machines were developed to more accurately and efficiently cut and shape wood into the desired shape.

Today, people woodwork to accomplish a wide variety of tasks or projects. Just as in early ages of civilization, humans today woodwork to create furniture, cabinets, art, and toys.

Woodworking and metal working machines utilize various means of positioning or securing a workpiece as it is cut, drilled or routed.

As standard equipment, a table saw normally has a rip fence for cuts parallel to the blade and a miter gauge for cutting at an angle to the blade.

One current practice is to add a piece of wood to the table saw, so as to provide a more stable surface to secure and control the workpiece. Thus, the work piece is supported closely adjacent to the blade and there is less splintering and tear out at the edge of the cut when the blade breaks through the rear surface of the workpiece.

Prior versions of commercially sold measuring systems include a flip stop arm that measures the desired position of a workpiece in relationship to a cutting tool, such as a saw blade, router bit, or drill bit.

A flip stop is known and referred to herein as a device mounted to a fence or track system which is commonly used with miter saws, drill presses, crosscut sleds, or router tables; designed to consistently and accurately position workpieces for cutting or drilling. Flip stops allow for quick, repeatable setups without the need to re-measure each time.

Some flip stop arms may be L-shaped, and therefore the long leg of flip stop arm can be in the vertical position so that it touches the end of the workpiece.

To bypass the cutting dimension, the flip stop arm must be raised out of the way, such that the workpiece can be repositioned. The disengaged position is when the flip stop arm is flipped upwards and out of the way so it is not in line with the workpiece and will not engage the end of the board.

Curved flip stop arms are able to self-elevate, but are currently large and bulky. The size causes excessive expense. Additionally, there is no option for adjusting to be retrofit into current extrusion tracks; users must purchase an entire workpiece in order to use such a flip stop.

Some issues that occur are that operators are required to spend processing time repositioning the flip stops. Also, current designs require excess material for the length and width.

What is needed, therefore, is a device which can utilize the self-elevating feature of the curved flip stop arm yet be compact and adjustable so as to fit a variety of track heights and aluminum extrusion track styles.

### BRIEF SUMMARY OF THE INVENTION

The present invention is directed to a system for aligning, guiding and/or holding a workpiece on woodworking or metal working machinery during an operation such as sawing, routing, or drilling and are described as well as methods of making, modifying, and using jigs and fixtures.

This patent application is an improved measuring system that is adjustable. There are a variety of different height adjustments, which can be used with a variety of available tracks.

In one embodiment the modular system mounting mechanism is a turned stepped and threaded member which is secured to the T-slot track.

Individual flip stop arms may be positioned on a threaded rod so as to create an efficient and easily positioned gang stop unit, which will allow an adjusted position through multiple cuts or holes without the operator needing to touch the flip stop arm. This saves processing time.

A version of the other three parts of the unit modular measuring system are aluminum extrusions. The central member in the preferred embodiment is a flat bracket extrusion with multiple rectangular raised flanges that fit in a T-slot opening in the rotating base which mounts to T-slot tracks.

The bracket in one embodiment has 9 flanges and has a central hole for mounting the unit to the rotating base.

The reversible bracket in one embodiment has five flanges on one side and four on the other side for a total of 9 different height options.

A reversible bracket in another embodiment has a round boss on one end for attaching the rotatable flip stop arm.

One embodiment has the extruded curved flip stop arm has a curved bottom with a central hole and sides that are mirror images of each other. The flip stop arm can be allowed to rotate freely or be secured tightly with a bolt and locked nut to the bracket so that it functions as a solid flip stop measuring system. Individual flip stop arms can thus be positioned on a threaded rod to create an efficient and easily positioned gang stop unit to position multiple cuts or holes without the operator needing to touch the flip stop arm.

These and various other features, advantages, modes, and objects of the present invention will be made apparent from the following detailed description and any appended drawings.

### BRIEF DESCRIPTION OF THE DRAWINGS

One or more preferred exemplary embodiments of the disclosed invention are illustrated in the accompanying drawings in which like reference numerals represent like parts throughout:

FIG. 1A is a perspective view of the adjustable flip stop measuring system secured to a double T-slot track;

FIG. 1B is an enlarged view of FIG. 1A illustrating the double T-slot track, along with the rotation base and an adjustable bracket of the preferred embodiment;

FIG. 1C is an enlarged perspective view of the adjustable and reversible flip stop assembly;

FIG. 1D is an end view of the rotation base extrusion;

FIG. 1E illustrates an end view of the bracket extrusion;

FIG. 1F is an exploded view of the turned flip stop base;

FIG. 1G is an end view of a curved U-stop flip stop arm;

FIG. 1H is a perspective view of a curved U-stop flip stop arm;

FIG. 2A is a perspective view of an adjustable flip stop measuring system;

FIG. 2B is a perspective view of an adjustable flip stop bracket;

FIG. 2C is a perspective view of a rotatable flip stop arm;

FIG. 2D is a perspective view of a rotatable flip stop arm with a bolt and a nut;

FIG. 2E illustrates a rotatable flip stop arm and an adjustable bracket;

FIG. 2F is a perspective view of an adjustable bracket illustrating the machined area of the round boss;

FIG. 3A is an end view of the rotation base;

FIG. 3B is an end view of the rotation base in a ¼ inch grid;

FIG. 3C is an end view of the curved flip stop arm;

FIG. 3D is an end view of the flip stop arm in a ¼ inch grid;

FIG. 3E is an end view of an adjustable bracket highlighting multiple flanges;

FIG. 3F is an end view of the rotation base in a ¼ inch grid;

FIG. 4A is a perspective view of an adjustable flip stop measuring system;

FIG. 4B is an end view of an adjustable bracket and a rotation base illustrated with solid lines;

FIG. 4C is a perspective view of a rotation base;

FIG. 4D is a perspective view of the flip stop arm illustrating the machined area;

FIG. 4E is an end view of a flip stop arm illustrated with solid lines;

FIG. 4F is an edge perspective of the adjustable and rotatable bracket;

FIG. 4G is a side perspective of the adjustable and rotatable bracket illustrating the removed material in the bolt hole area;

FIG. 4H is an enlarged view illustrating the elevated flange and hole in the middle of the flange;

FIG. 5A is an exploded perspective view of an embodiment of the present invention which is an adjustable flip stop measuring system;

FIG. 5B is an enlarged perspective view of the adjustable and reversible flip stop assembly bracket;

FIG. 5C is a turned flip stop base;

FIG. 5D is a perspective view of the adjustable and reversible flip stop assembly;

FIG. 5E is an end view of the adjustable bracket;

FIG. 6A is a perspective end view of the preferred embodiment;

FIG. 6B is a perspective end view of the preferred embodiment;

FIG. 6C is a perspective end view of the preferred embodiment;

FIG. 6D illustrates an adjustable and reversible flip stop assembly;

FIG. 6E is an end view of an adjustable bracket;

FIG. 7A illustrates a rotatable flip stop arm assembly with a tightened bolt which creates a solid flip stop unit;

FIG. 7B illustrates a flip stop arm secured to an adjustable bracket with a bolt;

FIG. 7C illustrates a solid flip stop assembly with a workpiece being pushed under a curved flip stop arm;

FIG. 7D illustrates a rotatable solid flip stop assembly with a workpiece underneath it;

FIG. 7E is a perspective view of a solid flip stop assembly secured to a dual T-slot extrusion;

FIG. 8A illustrates a rotatable flip stop arm showing the rotation of the arm with dotted lines;

FIG. 8B illustrates a rotatable flip stop arm of an adjustable flip stop assembly positioned on a L-shaped T slot extrusion;

FIG. 8C shows an adjustable flip stop system resting on the workpiece;

FIG. 8D illustrates a rotated flip stop arm in the vertical position with a bolt located in the round opening;

FIG. 8E is a reversed and exploded view illustrating the exploded view of the flip stop arm mechanism which includes a flip stop arm, a bolt, a nut, and a thumb nut;

FIG. 9A illustrates a rotatable flip stop arm showing the rotation of the arm with dotted lines;

FIG. 9B is a perspective view in the vertical position with a bolt located in the round opening of the small round boss. The thumb nut 36 is in the foreground of the illustration;

FIG. 9C is a perspective view of a micro adjustable flip stop arm;

FIG. 9D is a perspective view of a micro adjustable flip stop arm illustrated in the vertical position;

FIG. 9E shows the micro adjustable flip stop arm with a workpiece rotating the flip stop arm;

FIG. 9F shows a rotated flip stop arm with a workpiece located underneath it and against the fence extrusion;

FIG. 9G shows the “engaged” position with a micro-adjustable flip stop arm in contact with the end of a board;

FIG. 10A is a perspective view of a flip stop arm assembly illustrated with an adjustable bracket, a rotation base, and a flip stop arm;

FIG. 10B is a perspective view of a flip stop arm assembly illustrated with an adjustable bracket and a flip stop arm;

FIG. 10C is a perspective view of a flip stop arm assembly illustrated with an extrusion;

FIG. 10D is a perspective view of a flip stop arm assembly illustrated with an extrusion;

FIG. 10E is a perspective view of a flip stop arm assembly illustrated with an extrusion; and

FIG. 10F is a perspective view of a flip stop arm assembly illustrated with another miter gauge extrusion.

Before explaining one or more embodiments of the disclosed invention in detail, it is to be understood that this invention is not limited in its application to the details or modes of construction and the arrangement of the components set forth in the following description or previously disclosed illustrations.

This invention is capable of multiple embodiments and modes, which can be practiced or carried out in many various ways. Also, it is to be understood that the phraseology and terminology employed herein is for the purpose of description, and should not be regarded as limiting, or used as an absolute.

### DETAILED DESCRIPTION OF THE PREFERRED EMBODIMENT

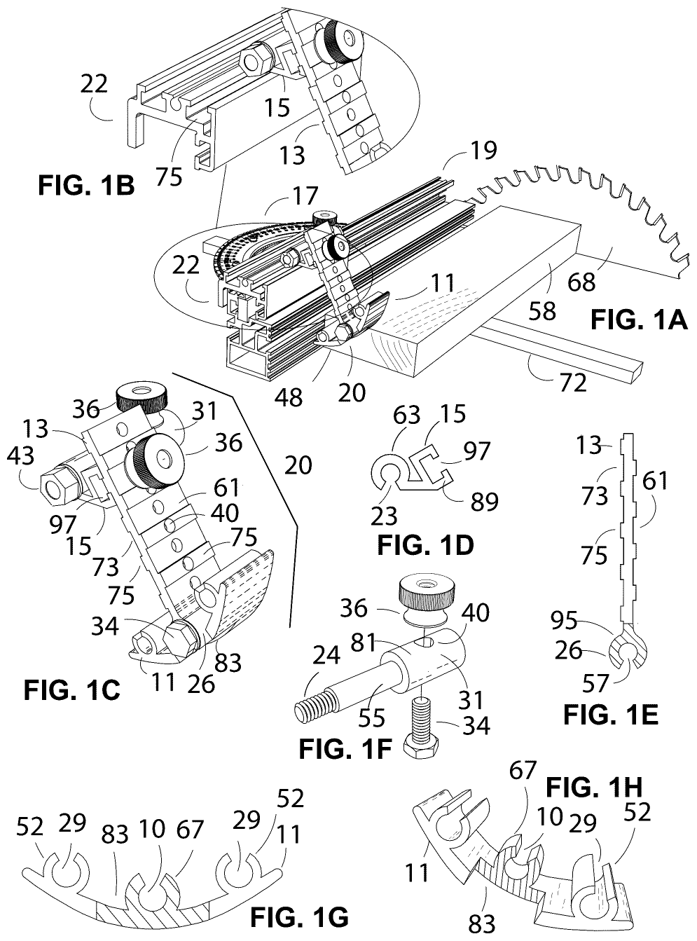

Referring to FIG. 1A, an adjustable flip stop measuring system 20 is provided, highlighting a curved flip stop 11. A workpiece 58 is positioned between the curved flip stop arm 11 and a saw blade 68 on a table saw. The workpiece 58 is located upon a miter gauge bar 72. As shown, the curved flip stop arm 11 is in the engaged position 48. This is known as when the curved flip stop 11 is in contact with the workpiece 58, which allows adjustment of the length of the workpiece 58.

FIG. 1B is a view of a double T-slot track 22, and highlighting a rotation base 15 being in contact with the miter gauge extrusion 22.

Turning to FIG. 1C, as shown, the rotation base 15 is located on the 5-flange side 73, which is also known as the second exterior face, of the adjustable bracket 13. The adjustable bracket 13 is presently thought of as generally rectangular. A thumb nut 36 is shown on the 4-flange side 61, also known as the first exterior face, of the adjustable bracket 13. One embodiment of the present embodiment is made with 3 aluminum extruded shapes and a round turned stepped base 31 that accepts a bolt 34 through as into a 5/16 crescent opening 23 in the rotation base 15. The bolt is secured with a fastener, such as a lock nut 43. As shown, multiple openings 40 are provided upon the adjustable bracket 13, the openings 40 extend through the first exterior face 61 and the second exterior face 73 of the adjustable bracket 13. The multiple openings allow for the maneuverability of the bolt 34 with the thumb nut 36 thereon, which secures the rotation base 15 to the adjustable bracket 13. Thus, a user can adjust the angle of the bracket 13 as to the rotation base 15 by adjusting which opening 40 to receive said bolt 34.

FIG. 1D is an end view of the rotation base 15, which shows the T-slot opening 97. The rotation base 15 may be an aluminum extrusion, with a 0.500″ diameter circular area 63 with a non-enclosed round 5/16″ crescent opening 23 contacted thereto. The T-slot 97 accepts and receives one of a flange 75 of the 5-flange side 73 of the adjustable bracket 13.

FIG. 1E illustrates an end view of the adjustable bracket 13, and further shows the long narrow shape, with a top end and a bottom end, wherein the bottom end additionally has a crescent opening 57 on the bottom end. The bracket extrusion 13 is a central frame to which the other extrusions are attached. A flange 75 is a rectangular shaped raised material from the body of the bracket 13. Here, there are nine staggered flanges 75, wherein each flange 75 has a 0.250″ diameter hole 40 located in the middle of it.

FIG. 1F shows a tubular flip stop base 31, having a threaded end 24 on one distal end. The flip stop base 31 has two turned areas. The larger turned diameter is ⅝″ 81. The round shape of the flip stop base 31 locks securely to the T-slot track opening 75 of the double T-slot track 22. The smaller area is turned to a 5/16″ (0.312″) diameter 55 and is the size of the round opening 23 in the extrusion of the rotation base 15. A ¼-20 thread 24 secures the rotation base extrusion 15 to the turned stepped flip stop base 31 with a lock nut 46.

FIG. 1G is the end view of the curved flip stop arm 11. The sides are mirror images of each other with a 0.500″ crescent opening 67 in the middle and located on the face. As referred to herein, the curved flip stop arm 11 has an upper face and a lower face, where there are three crescent openings 29.

Turning to FIG. 1H, in the center of the generally rectangular curved flip stop arm 11 is a generally square void 83.

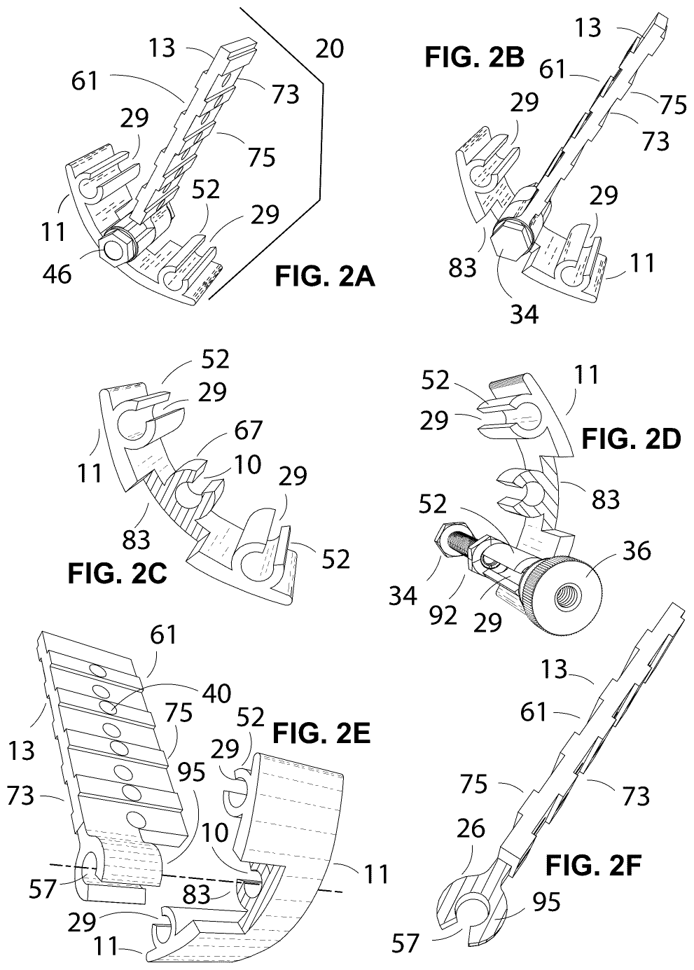

FIG. 2A-2B shows a perspective view of an adjustable flip stop measuring system 20, wherein the flip stop arm 11 is attached to an adjustable and reversible flip stop bracket 13 with a bolt 34 having a threaded shank 92 and a lock nut 46.

FIG. 2C is a perspective view of a rotatable flip stop arm 11 with a gentle curve with a round 0.250″ opening 10 in the middle, adjacent to the square void 83. Usually, the flip stop 11 weighs the same on both sides of the central opening 10.

FIG. 2D is a perspective view of a rotatable flip stop arm 11 with a bolt 34 and a nut 92 lined up with the round opening 29 in the 0.420″ crescent opening 52. The nut 92 can be used to micro adjust the position of the bolt head 34. The thumb nut 36 is used to lock the bolt 34 to the flip stop arm extrusion 11.

Looking at FIG. 2E and FIG. 2F, a perspective view of a rotatable flip stop arm 11 and an adjustable bracket 13 is shown, with the crescent opening of the bracket 57 is placed within the generally square void 83 of the curved flip stop arm 11. In such a fashion, a bolt 34 can be placed through the crescent bracket opening 57 and the crescent opening of the central crescent opening 10, which removably attaches the bracket 13 to the flip stop arm 11. The bolt is secured by a threaded fastener 46.

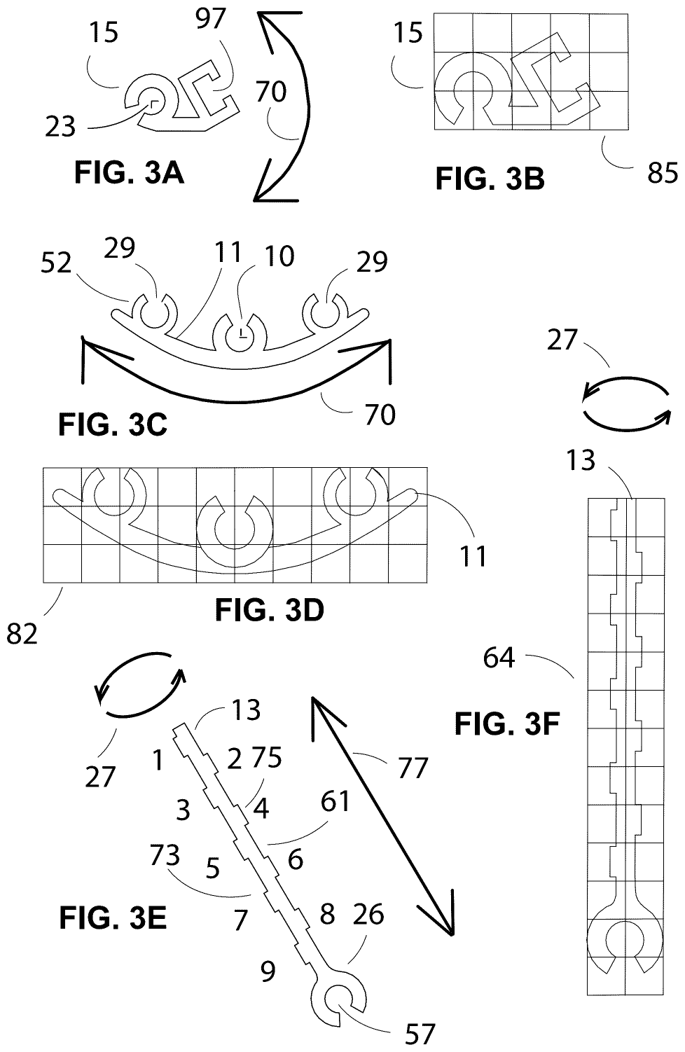

FIGS. 3A-3B shows the rotation base 15, with the rotation arrow 70 showing the arc of the rotation.

FIGS. 3C and 3D is an end view of the curved flip stop arm 11. The rotation arrow 70 shows the arc of the rotation.

FIGS. 3E and 3F shows an end view of an adjustable bracket 11 with an up and down arrow symbol 77 and a rotation symbol 27, having multiple flanges 75. The five flanges are designated with odd numbers on one side 73. The four flanges are designated with even numbers on the other side 61.

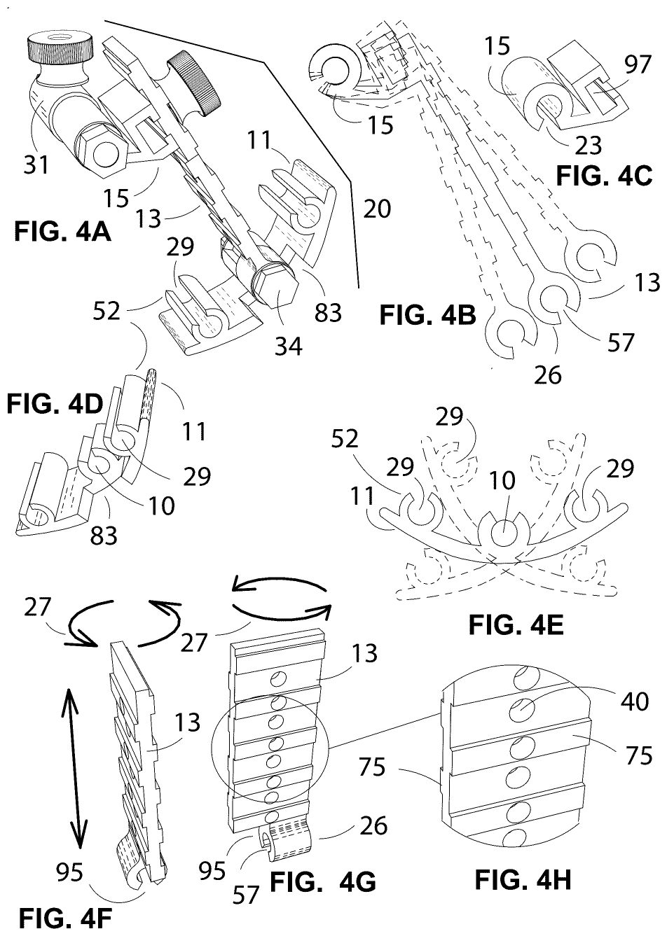

FIG. 4A is a perspective view of an adjustable flip stop measuring system 20.

FIG. 4B is an end view of an adjustable bracket 13 and the rotation base 15 illustrated with solid lines.

Now looking at FIGS. 4C, 4D, & 4E, perspective views of the rotation base and the flip stop arm are shown.

FIGS. 4F-4H shows perspective views of an adjustable and rotatable bracket 13 illustrating the elevated flange 75 and an opening 40 through the flange 75.

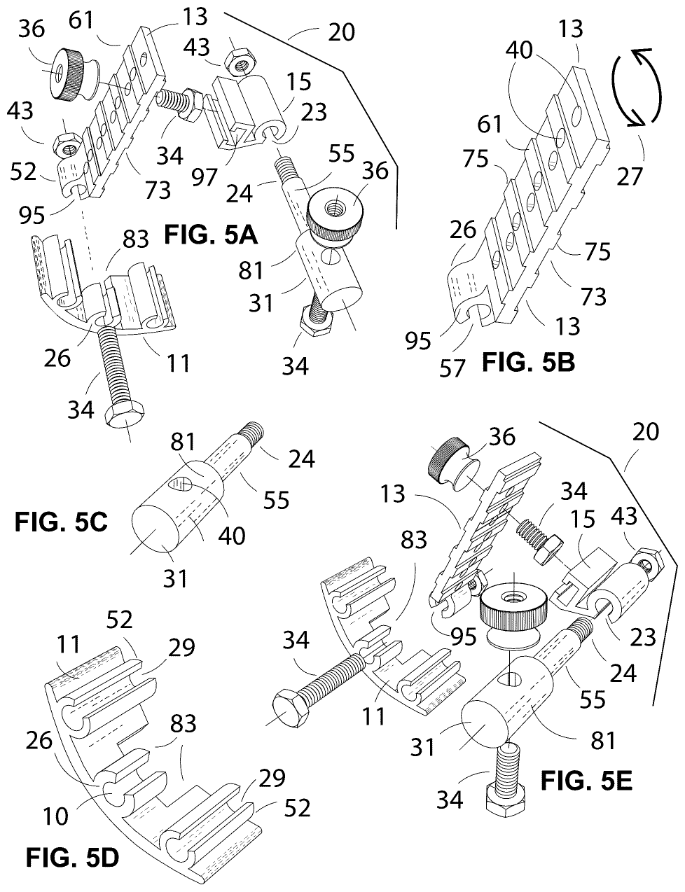

FIGS. 5A through 5E are exploded perspective views of an embodiment of the present invention which is an adjustable flip stop measuring system 20 made with 3 extruded shapes and a tubular flip stop base 31 which fits into the rotation base extrusion 15 5/16″ (0.312″) crescent opening 23. The round turned stepped base 31 has a ⅝″ (0.625″) diameter 81. The 5/16″ (0.312″) diameter 55 of the tubular flip stop base 31 fits into a round crescent opening 23 in the rotation base 15. The rotation base 15 is secured to the turned stepped flip stop base 31 with a lock nut 43. The rotation base 15 has a T-slot opening 97 that accepts a bolt 34 which secures an adjustable and reversible bracket 13. A flange 75 is a rectangular protrusion in the bracket extrusion 13 with a hole 40 in the middle of it. An adjustable bracket 13 has 9 alternating and staggered flanges 75 with a hole 40 in the middle of each flange. 5 Flanges are located on side 73 and four flanges are located on side 61. The rotation base 15 and the curved flip stop arm 11 are secured to an adjustable bracket 13. The rotation base 15, an adjustable bracket 13 and the curved flip stop arm 11 are aluminum extrusions that are cut to a one-inch length. The curved flip stop arm 11 has a round 0.500″ boss 26 with a round opening in the middle of it 57. An adjustable bracket is a long extrusion 13 with a round 0.500″ diameter boss 26 with a 0.250″ round opening in the middle of it 57.

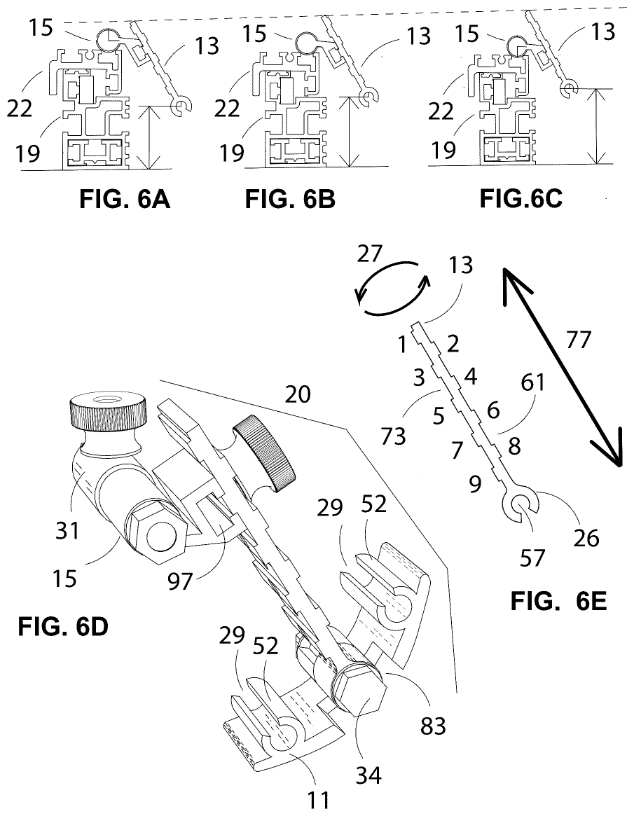

Now looking at FIGS. 6A through 6C, the adjustable bracket 13 with rotation base 15 is secured to a miter gauge extrusion 19 secured to a double T-slot track 22.

A perspective view of FIG. 6D is shown an adjustable and reversible flip stop assembly 20.

FIG. 6E is an end view of an adjustable bracket 13 with an up and down arrow symbol 77 and a rotation symbol 27.

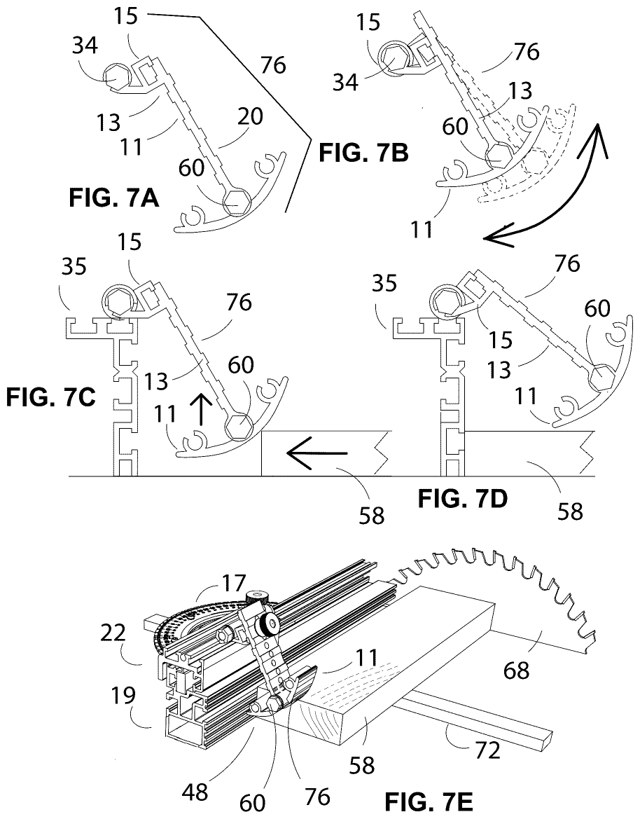

Looking at FIG. 7A through FIG. 7D, illustrates a rotatable flip stop arm assembly 20 with a tightened bolt 60 which creates a solid flip stop unit 76. The tightened bolt 60 allows the rotation base 15, bracket 13 and the flip stop arm 11 to function as a solid unit 76. The flip stop arm 11 is secured to an adjustable bracket 13 with a bolt 60 that is tight enough so that the extrusions function as a solid unit 76. The solid unit 76 is shown with solid lines. The rotation of the unit is illustrated with a dotted line. As the pressure from the workpiece 58 increases there is an upward vector pressure applied against the curved arm 11 which elevates the solid flip stop assembly 76.

This measuring system is modular parts which can be combined in different ways. Adjustable bracket length is the first decision to be made when developing a strategy for a measuring system set-up. Being able to adjust the length of bracket 13 allows the location of the flip stop arm 11 to be adjusted. An adjustable and reversible flip stop assembly 20 adapts to 9 different possible fence heights because it employs 9 different evenly spaced flanges with a central mounting hole in the center of each flange. The illustration shows the flip stop arm 11 is locked with the bolt 60 to create a solid unit 76. The bracket 13 location has been adjusted so that the edge of the workpiece 58 contacts the locked flip stop arm 11 near the locked bolt 60. Experimentation will help determine which flip atop arm angle is most efficient. This illustration shows that the small boss 52 hole opening 29 is lower than the height of the workpiece 58. If a micro adjustment bolt 34 was placed in the boss opening 29 it would be aligned with the end of the board 58.

FIG. 7D illustrates a rotatable solid flip stop assembly 76 with the workpiece 58 underneath it. This is the “stand-by” position 88 because the flip stop arm 11 is not in contact with the end of the workpiece 58. If the workpiece 58 is removed, gravity will allow the solid flip stop assembly 76 to drop down on the tabletop to the engaged position 48.

FIG. 7E is a perspective view of the solid flip stop assembly 76 secured to a dual T-slot extrusion 22. The end of the workpiece 58 is in contact with the curved arm 11 which is the “engaged” position 48. The workpiece 58 is positioned between the curved flip stop arm 11 and the circular saw blade 68. All of the workpieces 58 that are crosscut with this machine set-up would be the same length.

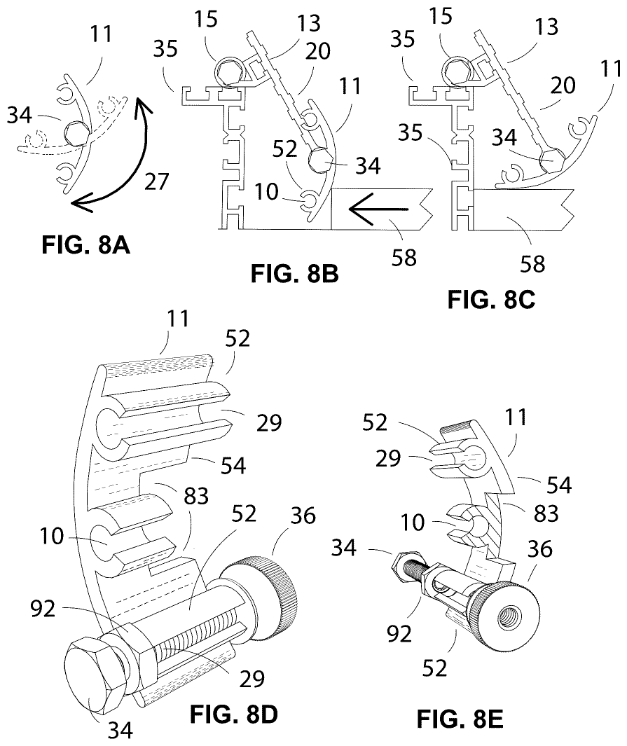

FIG. 8A through 8C shows a rotatable flip stop arm 11 of an adjustable flip stop assembly 20 positioned on the L-shaped T slot extrusion 35. The lock nut 43 secures the rotation base 15 to the turned flip stop base 31. There are three options for tightening the lock nut 43. The lock nut 43 can be loose, allowing the bracket 13 and the arm 11 to rotate. The lock nut 43 can be locked. That would allow the flip stop arm 11 to be the only rotating part. The lock nut 43 can be locked at an angle other than 30 degrees. The 30 degree angle of the bracket 13 allows a wood fence guard to be added. The extrusion 19 also has a T-slot for a zero-clearance fence.

FIG. 8D and FIG. 8E illustrates a rotated flip stop arm 11 in the vertical position with a bolt 34 located in the round crescent opening 29 of the small round boss 52. The micro adjustable flip stop arm mechanism 54 includes the flip stop arm, the bolt 34, the nut 92 and the thumb nut 36. The location of bolt 34 is position by the nut 92 on one end and the thumb nut 36 on the other end. This design allows the bolt 34 to be adjusted in small increments.

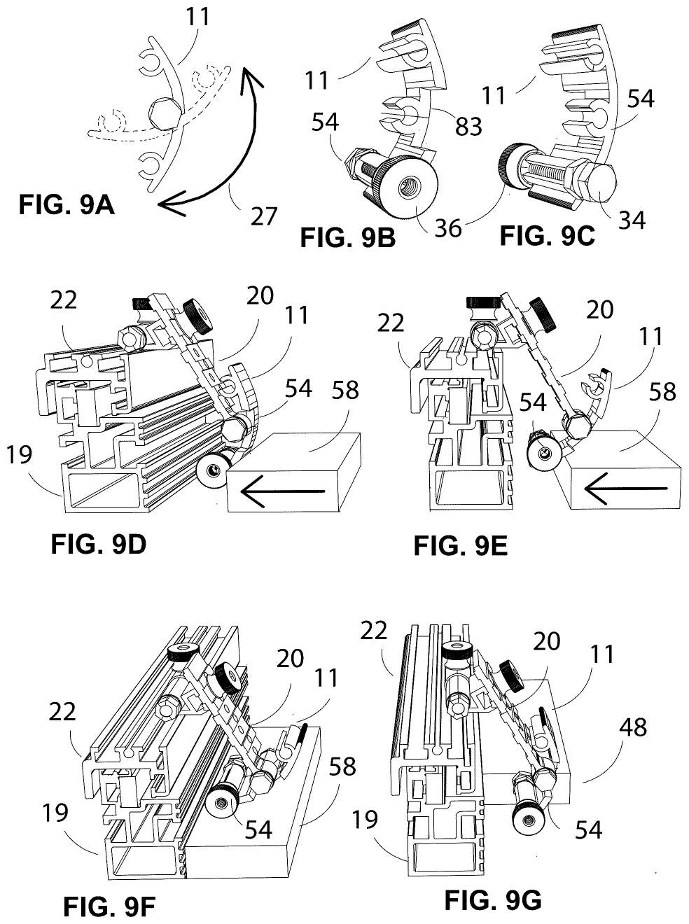

Looking to FIG. 9A, a rotatable flip stop arm 11 is shown, displaying the rotation of the arm with dotted lines.

FIGS. 9B and 9C are perspective views of the micro-adjustable flip stop arm 54 in the vertical position with a bolt 34 located in the round opening 29 of the small round boss 52. The thumb nut 36 is in the foreground of the illustration.

FIGS. 9D and 9E are perspective views of the micro adjustable flip stop arm 54 illustrated in the vertical position. The workpiece 58 is in contact with the vertical micro adjustable flip stop arm 54.

FIG. 9F shows a rotated flip stop arm 11 with the workpiece 58 located underneath it and against the fence extrusion 35. This illustration represents the “stand-by” position.

FIG. 9G shows the “engaged” position 48 with the micro-adjustable flip stop arm 54 in contact with the end of the board 58.

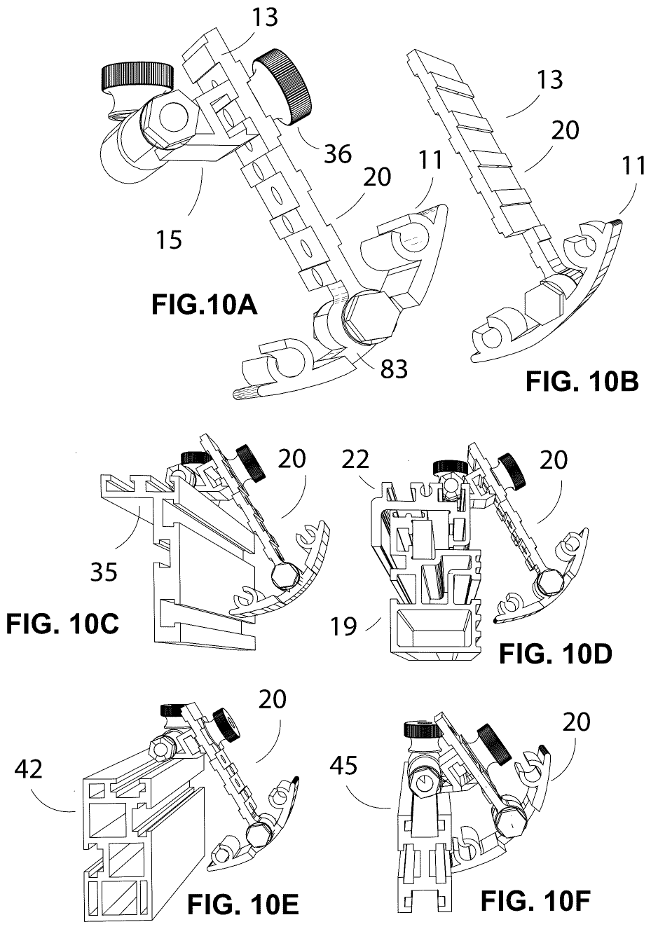

FIG. 10A through 10F are perspective views of the flip stop arm assembly 20 illustrating an adjustable bracket 13, the rotation base 13 and the flip stop arm 11, with multiple different miter gauge extrusions 19 and miter gauge extrusions 42.

Understandably, the present invention has been described above in terms of one or more preferred embodiments and methods. It is recognized that various alternatives and modifications may be made to these embodiments and methods that are within the scope of the present invention. Various alternatives are contemplated as being within the scope of the present invention.

It is also to be understood and appreciated that, although the foregoing description and drawings describe and illustrate in detail one or more preferred embodiments of the present invention, to those with skill in the art to which the present invention relates, the present disclosure will suggest many modifications and constructions, as well as widely differing embodiments and applications without thereby departing from the spirit and scope of the invention and method disclosed thereof.

What is claimed is:

1. A rotatable flip stop assembly comprising:
a curved flip stop arm having an upper and a lower face;
wherein the curved flip stop arm is generally rectangular;
wherein the curved flip stop arm has a generally square void defined by a square-shaped region substantially centered within the curved flip storm arm between the upper face and the lower face thereof, bounded on all sides by the upper face and the lower face;
a crescent opening located on the upper face of the curved flip stop arm disposed adjacent to the generally square void;
a second crescent opening disposed on the upper face of the curved flip stop arm disposed at a distal end of the curved flip stop arm;
a third crescent opening disposed on the upper face of the curved flip stop arm disposed at a distal end of the curved flip stop arm opposite the distal end of the second crescent opening;
a generally rectangular adjustable bracket having a first exterior face and a second exterior face and further comprising a top end and a bottom end, wherein the bottom end of the adjustable bracket further comprises a crescent opening thereon, wherein the crescent opening of the adjustable bracket is located within the generally square void of the curved flip stop arm such that the crescent opening of the adjustable bracket is in contact with the crescent opening of the curved flip stop arm; and
a bolt extending through the crescent opening of the adjustable bracket and the crescent opening of the curved flip stop arm removably securing the crescent opening of the adjustable bracket to the crescent opening of the curved flip stop, further comprising a threaded fastener received and threaded onto the bolt.

2. The rotatable flip stop assembly of claim 1, wherein the first exterior face of the adjustable bracket further comprises four flanges thereon.

3. The rotatable flip stop assembly of claim 2, wherein the second exterior face of the adjustable bracket further comprises five flanges thereon.

4. The rotatable flip stop assembly of claim 3, further comprising multiple openings extending through the first exterior face and the second exterior face of the adjustable bracket.

5. The rotatable flip stop assembly of claim 4, further comprising a second bolt having a bolt head and a threaded shank, wherein the second bolt is extending through one of the multiple openings of the first exterior face and the second exterior face of the adjustable bracket.

6. The rotatable flip stop assembly of claim 5, further comprising a rotation base having a T-slot opening, wherein the T-slot opening is in contact with a 5/16 inch crescent opening located thereon, wherein the head of the second bolt is received within the T-slot opening of the rotation base.

7. The rotatable flip stop assembly of claim 6, further comprising a thumb nut mechanically fastened to the threaded shank of the second bolt.

8. The rotatable flip stop assembly of claim 7, further comprising a tubular flip stop base having a threaded distal end, wherein the threaded distal end of the tubular flip stop base is received within the 5/16 crescent opening of the rotation base, and further extends therethrough.

9. The rotatable flip stop assembly of claim 8, further comprising a lock nut, received and threaded onto the threaded distal end of the tubular flip stop base.

10. The rotatable flip stop assembly of claim 9, further comprising an opening extending through the tubular flip stop base, and further comprising a third bolt received and extended through the tubular flip stop base, further comprising a thumb nut mechanically fastened to the third bolt.

11. The rotatable flip stop assembly of claim 10, further comprising a miter gauge extrusion, wherein the rotation base is in contact with the miter gauge extrusion.

12. The rotatable flip stop assembly of claim 11, further providing a table saw, wherein the miter gauge extrusion is placed onto the table saw.
